(19) United States
(12) Patent Application Publication
(10) Pub. No.: US 2018/0170292 A1
(43) Pub. Date: Jun. 21, 2018

(54) PERSONALIZATION OF A VEHICLE

(71) Applicant: DAIMLER AG, Stuttgart (DE)

(72) Inventors: Oliver FRITZ, Ostfildern (DE); Antonius QUELL, Böblingen (DE); Marco SANTI, Gärtringen (DE); Susanne SCHILD, Gärtringen (DE); Stephan VENNEBÖRGER, Tübingen (DE); Manja ZEDLER, Stuttgart (DE)

(21) Appl. No.: 15/736,542

(22) PCT Filed: Jun. 2, 2016
(86) PCT No.: PCT/EP2016/000904

§ 371 Date: Dec. 14, 2017

(30) Foreign Application Priority Data
Jun. 17, 2015 (DE) 10 2015 007 741.4

(51) Int. Cl. B60R 16/037; B60K 37/02

(52) U.S. Cl. CPC B60R 16/037; B60K 2350/1076; B60K 37/02

(57) ABSTRACT

A control device and a method for operating a vehicle using one of several profiles, each of which contains user-specific settings data for the vehicle. An initial selection of the profile is carried out via an instrument cluster of the vehicle. In contrast, changing and/or managing the respective selected profile is carried out with a head unit of the vehicle.

### BACKGROUND AND SUMMARY

Exemplary embodiments of the present invention relate to a method for operating a vehicle by providing several profiles, each of which contain user-specific settings data for the vehicle, initial selection of one of the profiles and changing and/or managing the respective selected profile by means of a head unit of the vehicle. Moreover, exemplary embodiments of the present invention relate to a corresponding control device for a vehicle having a storage device for providing several profiles, each of which contain user-specific settings data for the vehicle, and having an instrument cluster and a head unit for changing and/or managing the respective selected profile.

Vehicles such as passenger cars, heavy goods vehicles, motorbikes and similar generally have a so-called instrument cluster. This is understood to mean an instrument cluster that typically consists of a combination of a tachometer, an odometer, a revolution counter, a fuel gauge, a coolant temperature gauge, several dashboard warning lights, and a direction indicator (indicator). The instrument cluster has the task of communicating basic vehicle data to the driver during the operation of the vehicle. This information must therefore be provided without great delay immediately after operation has begun.

Additional functions are also optionally assumed by the instrument cluster, such as, for example, displaying the time or the outside temperature. In order to be able to clearly communicate all this information, mechanical displays are being used less and less and electronic displays are increasingly being used.

In addition to an instrument cluster, modern vehicles also have a so-called head unit. This usually serves to process any audio data, video data, navigation data, or similar. Such data is produced in so-called infotainment systems of a vehicle. An infotainment system of this kind is generally understood to be a combination of a car radio, navigation system, hands-free device, driving assistance system and/or other functions in a central operating unit. The head unit generally represents a computer unit for processing data associated with these functions. A motherboard having memory modules and CPU as well as DSPs or similar is usually necessary for this. Optionally, a GPS receiver or similar is also integrated.

A method and a device for the storage and retrieval of individual settings is known from the publication German patent document DE 100 12 756 A1. The settings concern operationally relevant, electronically configurable or adjustable elements in the motor vehicle, and the corresponding data is displayed with help of a multifunctional display representation. To ensure that each user can also access the seat settings and, optionally, also other personal settings more easily, a user identification or user assignment is requested on a display when the vehicle is started, wherein either a corresponding existing identification, i.e., one which is already stored, is to be entered, or a guest identification takes place by pressing a button. The display for the settings is located, for example, in the center console. Basic settings for air-conditioning and heating systems and radio stations, for example, can also be operated here.

One problem with head units or infotainment systems is that they demand an extensive initialization process due to their complexity. This so-called booting up can take several seconds, which is perceived as a very long time under certain circumstances when starting a vehicle. Correspondingly, the individual settings data profile can only be selected after this initialization phase. If the user would like to select a profile, the start of the journey is correspondingly delayed by a time period of booting up the head unit and selecting the corresponding profile.

Exemplary embodiment of the present invention are directed to expediting the configuration of personal data in a vehicle.

A method for operating a vehicle by providing several profiles, each of which contain user-specific settings data for the vehicle is therefore proposed according to the invention. In this way, each person who wants to use the vehicle can obtain stored individual settings data. This data can then be easily accessed, as it is combined in a profile. Upon starting the operation of the vehicle, an initial selection of one of the profiles must correspondingly be made. This initial selection can take place automatically or, however, also manually, by a corresponding input by the driver or user. The profile can be changed when operating the vehicle, when, for example, the driver changes, or a different vehicle dynamic is desired. This change typically takes place by means of the head unit of the vehicle. Changing the profile is generally not time critical, as the initially selected profile was previously used to operate the vehicle. Managing each selected profile is even less time critical. In this regard, it is entirely appropriate to change or manage the profile via the head unit of the vehicle. In contrast, the initial selection of one of the profiles is carried out according to the invention by means of an instrument cluster of the vehicle. The instrument cluster is generally available immediately upon starting the vehicle, without a noticeable booting up phase being required. It is therefore advantageous when the initial selection of a profile upon starting the operation of the vehicle is carried out not by means of the head unit but with help of the instrument cluster.

It should be noted that all user-operable settings in the vehicle can be part of personalized settings data of one or more of the profiles.

In one embodiment, changing and/or managing each selected profile during the operation the vehicle is carried out exclusively by means of the vehicle's head unit. The instrument cluster is thereby not overloaded and the computationally intensive functions remain limited to the head unit. The starting of the instrument cluster is thereby also not delayed by these functions.

At least one of the profiles can have settings data for a seat, a steering wheel and/or a mirror. The vehicle can thus be specifically personalized, particularly for differently sized people using the same vehicle. Personal settings data for the seat, steering wheel or mirror are then saved in the respective profile.

In addition, at least one of the profiles can have a so-called configuration set. A configuration set is understood to be combinations of settings data that are independent of one other. For example, a specific illumination profile can be combined with a driving program in a configuration set. Such combinations can also be saved in the various personal profiles.

Furthermore, at least one of the profiles can have settings data for an individual driving program and/or a predetermined driving program and/or an automatic start-stop system. In addition to standard driving programs, personally constructed driving programs and other driving functions can also be stored in the profiles.

Preferably, a recently activated driving profile is automatically preselected. This has the advantage that a driver who repeatedly uses the same vehicle does not have to make a time-consuming selection each time they use the profile. In fact, the vehicle can “remember” the profile that was used or activated most recently before a restart.

Using a profile also requires the activation of a selected or preselected profile. In one advantageous embodiment, the selected or preselected profile is automatically activated by a vehicle initialization process, such as, for example, switching on the ignition or starting the vehicle's engine. In this case it is not necessary for the driver to activate an additional operating element to activate a profile. In fact, the activation is automatically triggered by the initialization process.

According to embodiments of the present invention, a control device for a vehicle having a storage device for providing several profiles which contain user-specific settings data for the vehicle is also provided. In addition to this storage device, the control device also has an instrument cluster and a head unit. As in the method described above, changing and/or managing each of the selected profiles is also carried out here with help of the head unit, as this is not time critical. The initial selection of one of the profiles is, however, carried out by the instrument cluster, which is almost immediately available with its full range of functions during the initialization process of a vehicle.

As an alternative to the initial profile selection in the instrument cluster during the vehicle's initialization process, as a special case, a user can start the head unit manually via the instrument cluster before selecting a profile and then has the option of selecting the initial profile simultaneously in the instrument cluster and in the head unit.

The instrument cluster preferably has a tachometer and/or an odometer and/or a revolution counter and/or a fuel gauge. Further functions such as the time, outside temperature, oil level indicator etc. can be integrated into the instrument cluster. The instrument cluster thus reproduces the most important operational data of the vehicle.

In one preferred embodiment, the head unit has a computer unit for audio data processing and/or for video data processing and/or for navigation data processing. Therefore, for example, the control of a car radio, a CD player, a display and/or a navigation system is enabled via the head unit.

The method features described above in connection with the method according to the invention can also be seen as functional features of the above-mentioned control device. Conversely, corresponding functions are offered by the above-mentioned physical units, which can also be implemented as a method feature.

### BRIEF DESCRIPTION OF THE DRAWING FIGURES

The present invention is now explained in more detail using the accompanying drawings, which show:

FIG. 1 a basic flow chart for the initial selection of a profile having settings data via an instrument cluster of a vehicle;

FIG. 2 a menu item for managing profiles of a head unit of a vehicle and

FIG. 3 a basic sketch of a part of a motor vehicle having instrument and head unit.

### DETAILED DESCRIPTION

The exemplary embodiments described in more detail below represent preferred embodiments of the present invention. It should be noted here that the individual features can be implemented not only in the described combinations, but also in other technically meaningful combinations or individually.

The following examples set out how a vehicle or motor vehicle can be personalized. The data that was generated or stored specifically for one person is used in the vehicle for configuring the vehicle. The settings data is thus stored in a respective personal profile. One person can optionally use several profiles. Under certain circumstances the profiles can also be dynamically adapted, wherein, for example, a personal so-called “last mode” is stored in a profile. The profile then contains the vehicle settings and data from the last use of the vehicle by the person. These vehicle settings and data, i.e., the profile, can then be recalled for a future journey.

One particular additional value of this function of using profiles arises in particular when a vehicle is used by many drivers. Each driver has access to his/her own profile in a favorable manner. Therefore, for example, seats can be individually adjusted if the driver has selected his/her personal profile with the seat settings data. However, one driver can also possess several profiles, in order to, for example, use different dynamic driving characteristics of the vehicle in a correspondingly composed way.

Different content or data representing concrete personalization can be stored in one profile. Therefore, for example, vehicle settings for a seat, for the steering wheel and/or for the mirror/mirrors can be chosen in one profile. Furthermore, so-called configuration sets can also be stored in a profile. These are, for example, combinations of vehicle settings data. Specifically, such a combination of settings data can relate to length and size settings of the mechanical components of the vehicle, or also, for example, a driving program and/or a light setting or additional settings.

Furthermore, the profiles can also be used to configure individual driving programs for profiles. In contrast to predetermined driving programs, each driver can individually create his/her own respective driving program. Furthermore, driving programs can also be combined in one profile with other functions such as, for example, an automatic start-stop system. Optionally, profiles can also be combined with time settings. Therefore, for example, it would be possible that after a certain period of time, the vehicle could only be started with a standard driving program.

In known methods, the selection and management of profiles has consistently been carried out by means of the head unit. However, due to the fact that the head unit, like a PC, requires a certain amount of time to boot up, since it is also a more or less complex computer unit, corresponding time delays are to be expected at the start of operation of a vehicle with respect to the selection of a profile. Provision is therefore made according to the invention for initial selection to take place immediately after entering the vehicle, for example when switching on the ignition, and before driving the vehicle, not using the head unit but using the instrument cluster of the vehicle. The instrument cluster is generally available significantly more quickly than the head unit. In this respect, the initial profile selection can be carried out more quickly using the instrument cluster upon starting the vehicle than selection using the head unit according to prior art.

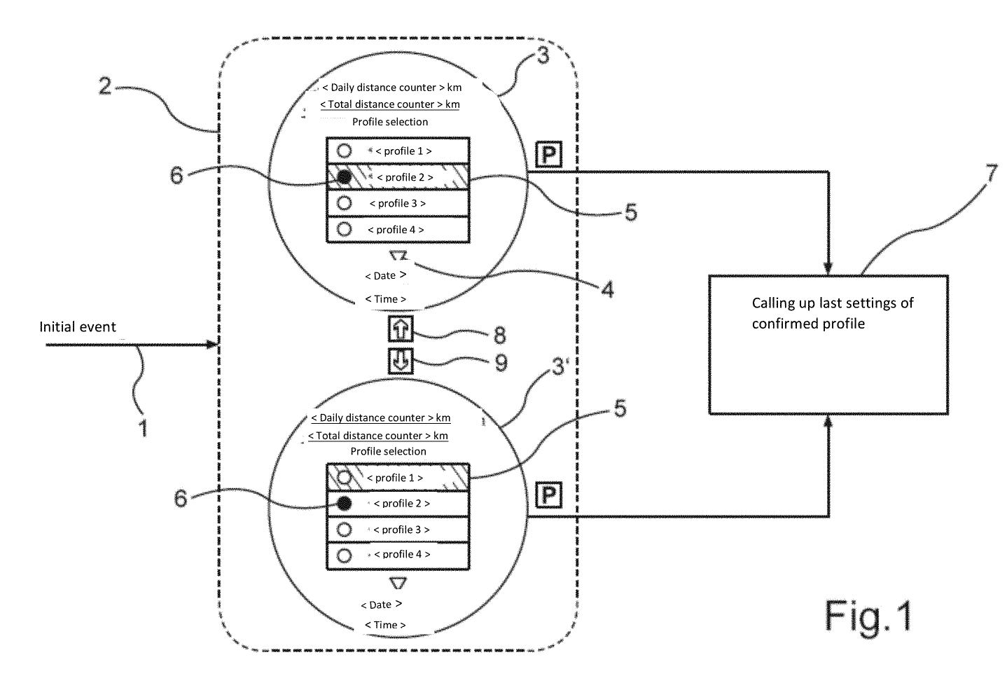

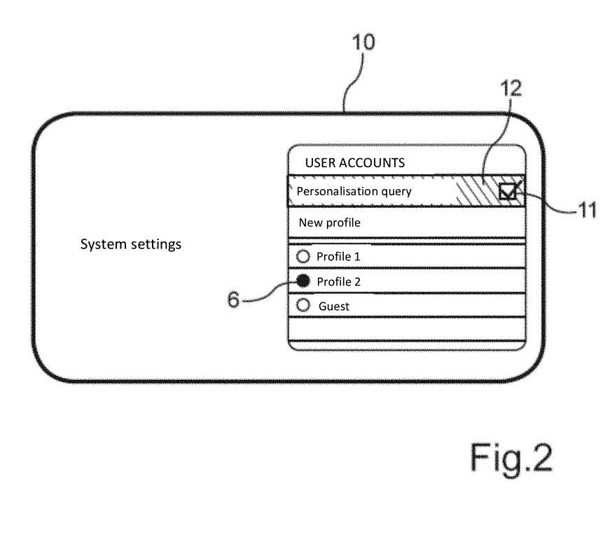

It will now be explained how the respective profiles can be selected, activated and managed with reference to FIGS. 1 and 2.

FIG. 1 shows a corresponding flow chart for the initial selection of a profile with the aid of an instrument cluster. An initial event 1 effects a profile selection 2 via the instrument cluster. The initial event 1 may be the unlocking of a vehicle, the opening of a vehicle door, the closing of a vehicle door or the insertion of an ignition key. In any case, the initial event indicates that the vehicle should/could be restarted. Optionally, therefore, the instrument cluster is “woken up” to allow a corresponding profile selection 2.

As part of the profile selection 2, the instrument cluster can show the profile selection menu 3 on a display. Under certain circumstances, the profile menu is shown embedded in other displayed data. In the present example, the mileage of a daily distance counter and the mileage of a total distance counter are displayed above the profile selection. Beneath the profile selection, the date and the time are shown in this example. However, other data or also no data can also be displayed in addition to the profile selection.

Four directly selectable profiles “profile 1” to “profile 4” are shown here directly for the profile selection. An arrow 4 indicates that additional profiles can be called up.

The cursor for the selection is graphically designed here such that each box which represents one of the profiles is indicated with a special color or lighting. In the menu 3 of FIG. 1, the cursor 5 rests on <profile 2>. If a corresponding confirmation button or a confirmation field were pressed now, as represented in FIG. 1 by the symbol “P”, then the settings data of profile 2 would be loaded into a corresponding control system or otherwise used by the vehicle.

As an optional auxiliary function, the profile that was last selected is indicated by a point 6 in the menu 3. This optional auxiliary function therefore indicates which profile or which settings data or which configuration set was previously selected. When “P” of the operating unit is pressed, since the cursor 5 and the marker point 6 are both on <profile 2>, the last settings of the confirmed profile are therefore recalled 7.

If another profile is now manually selected, then corresponding cursor keys 8, 9 should be actuated or corresponding swipe movements should be performed or desired menu items should be tapped. According to the menu illustration 3′, the cursor 5 here has been guided by way of example to <profile 1>. The point 6 marks the last selected profile <profile 2> as before. If, therefore, the menu selection of menu 3′ is confirmed by pressing “P” of a confirmation button or by another confirmation action, then the preselected profile 2 (see point 6) is not selected, but instead <profile 1> currently selected with the cursor 5 according to reference numeral 7 is called up, wherein the confirmed profile is characterized by the last settings applied.

Only a first, i.e., initial, selection of a profile with settings data and similar is possible in the instrument cluster. If, on the other hand, the profile is to be changed or otherwise managed during operation, this is preferably only possible with the aid of the head unit of the vehicle. This head unit of the aforementioned type offers, for example, a special menu 10 for calling up and managing profiles, for example according to FIG. 2. A submenu item there relates to user accounts where the individual profiles can be called up or managed. In the present example, it is possible in the user accounts menu to configure whether or not a personalization request should take place upon starting the vehicle. If this is desired, a corresponding tick 11 can be put in place by placing the cursor 12 on the corresponding menu item “request personalization” and is put in place or undone by a confirmation action.

A further menu item relates to the creation of a new profile. For this, the cursor 12 is placed over the menu item “new profile”. Finally, this menu item must be confirmed and corresponding profile entries must be carried out.

The individual profiles “profile 1”, “profile 2” and “guest” are shown for selection as further menu items in the menu 10, for example. To change the currently active profile, the cursor 12 must be guided to the desired profile and the profile confirmed. The last profile used before the restart can be indicated by a point 6 here too. Alternatively, the currently active profile can also be marked with point 6.

The menus shown in FIGS. 1 and 2 are purely exemplary. The menus can also have a different layout or a different structure or be differently named.

An initial selection of one of the profiles by means of the instrument cluster of the vehicle is thus carried out in an advantageous manner, while a change or management of the profiles is carried out in the head unit of the vehicle's infotainment system. Content such as vehicle settings (for the seat, steering wheel and mirror), configuration sets, individual driving programs, standard driving programs, and automatic start-stop systems or similar can be stored in the respective profile.

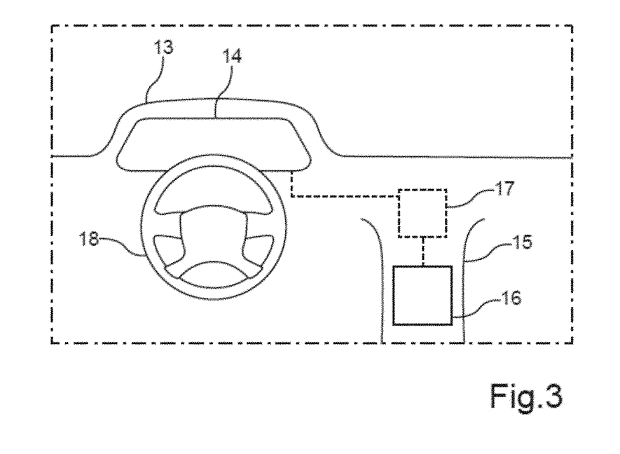

In FIG. 3, an example of a control device for a vehicle is shown schematically. An instrument cluster 14 is arranged in a dashboard 13. A center console 15 of the vehicle houses a head unit 16, which is represented here by its screen. Both the head unit 16 and the instrument cluster 14 access a storage device 17, in which the above-mentioned profiles, with which the vehicle can be individually configured, are stored. For example, the height settings of a steering wheel 18 or a preferred driving program or its identification are stored in such a profile. In order to be able to restart the vehicle more quickly, the initial selection of a profile upon restarting takes place by means of the instrument cluster 14, and when changing the profile or managing the profiles by the head unit 16.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for operating a vehicle, the method comprising:
providing several profiles, each of which contain user-specific settings data for the vehicle;
initially selecting one of the profiles using an instrument cluster of the vehicle; and
changing and/or managing the selected profile using a head unit of the vehicle.

12. The method of claim 11, wherein the changing and/or managing the profile during operation of the vehicle is performed within the vehicle exclusively using the head unit of the vehicle.

13. The method of claim 11, wherein at least one of the profiles has settings data for a seat, a steering wheel, and/or a mirror.

14. The method of claim 11, wherein at least one of the profiles has a configuration set.

15. The method of claim 11, wherein at least one of the profiles has settings data for an individual driving program, a predetermined driving program, or an automatic start-stop system.

16. The method of claim 11, wherein a recently activated profile is automatically preselected as the initially selected profile.

17. The method of claim 11, wherein a selected or preselected profile is automatically activated as the initially activated profile when the vehicle's ignition is switched on.

18. A vehicle control device, comprising:
a storage device configured to store several profiles, each of which contain user-specific settings data for the vehicle;
an instrument cluster configured to allow initial selection of one of the profiles; and
a head unit configured to change and/or manage the selected profile.

19. The vehicle control device of claim 18, wherein the instrument cluster has a tachometer, an odometer, a revolution counter, and/or a fuel gauge.

20. The vehicle control device of claim 18, wherein the head unit has a computer unit configured to process audio data, video data, and/or navigation data.
